(19) United States
(12) Patent Application Publication
(10) Pub. No.: US 2019/0354889 A1
(43) Pub. Date: Nov. 21, 2019

(54) METHOD OF PREDICTING FAILURE PROBABILITY OF BRITTLE MATERIAL IN HIGH TEMPERATURE CREEP STATE

(71) Applicant: CHINA UNIVERSITY OF PETROLEUM (EAST CHINA), Qingdao (CN)

(72) Inventors: Yucai ZHANG, Qingdao (CN); Wenchun JIANG, Qingdao (CN); Huiqin ZHAO, Qingdao (CN); Shandong TU, Qingdao (CN); Xuefang XIE, Qingdao (CN); Xiang LING, Qingdao (CN)

(21) Appl. No.: 16/476,004

(22) PCT Filed: Dec. 20, 2017
(86) PCT No.: PCT/CN2017/117405

§ 371 Date: Jul. 3, 2019

(30) Foreign Application Priority Data
Aug. 16, 2017 (CN) 201710699545.X

(51) Int. Cl. G06N 7/00; G06F 17/50

(52) U.S. Cl. CPC G06N 7/005; G06F 2217/10; G06F 17/5009

(57) ABSTRACT

Disclosed is a method of predicting a failure probability of a brittle material in a high temperature creep state. Based on the prior art, assuming that an uniaxial creep failure strain obeys Weibull Distribution in combination with a natural attribute of random distribution of internal defects of the brittle material, a probability density distribution curve of the uniaxial creep failure strain is obtained by using an uniaxial creep test, and a probability density function of a multiaxial creep failure strain is obtained based on a conversion relationship of uniaxial and multiaxial creep failure strains and further a calculation model of a failure probability is obtained by integration; based on this, a prediction result of a failure probability of the brittle material in the high temperature creep state is obtained by writing a sub-program by using a Fortran language and embedding the sub-program into a finite element software in combination with a creep-damage constitutive equation. This present disclosure solves a technical problem that a reliability prediction cannot be performed for a brittle material in a high temperature creep state in the prior art, and the obtained prediction result is true, accurate, reasonable and reliable.

### TECHNICAL FIELD

The present disclosure relates to the field of reliability engineering technology, and in particular to a method of predicting a failure probability of a brittle material in a high temperature creep state.

### BACKGROUND

At present, a failure assessment work at home and abroad is performed mainly based on a principle of “Fitness for Service” of deterministic fracture mechanics According to this method, analysis is performed by using given values of parameters such as structure, defect and material performance in combination with a given safety coefficient to produce an assessment result of safety or non-safety.

However, in practical engineering, internal defects of a brittle material are randomly distributed and its structural size, material performance parameter, and load and so on are also non-deterministic and can be regarded as random variables with a given distribution.

Thus, a processing method of taking all parameters as single-value determination amounts in the deterministic fracture mechanics will allow an assessed structure to greatly deviate from an actual situation and even obtain a wrong assessment result.

To research on the impacts of different non-deterministic factors on structural failure and quantitatively assess safety of a structure containing a defect, an assessment method of probabilistic fracture mechanics comes up.

The probabilistic fracture mechanics takes non-deterministic variables as random variables obeying a given distribution. Representing a danger degree with a failure probability provides an accurate quantitative index for assessment of a safety degree of a structural member in an engineering application and guides reliability designing and life prediction by use of this theory and method.

An existing calculation expression of Weibull Distribution failure probability is based on stress. However, a stress relaxation effect will inevitably occur to a brittle material in a high temperature creep state and a stress quickly decreases close to zero. At this time, if the calculation expression based on stress is adopted for calculating a failure probability, a great deviation will be generated and a contrary conclusion may even be obtained.

Therefore, the calculation expression of Weibull Distribution failure probability in the prior art is not suitable for assessing the reliability of the brittle material in the high temperature creep state and it is required to establish a new failure probability calculation model.

### SUMMARY

To solve defects existing in a calculation expression of Weibull Distribution failure probability in the prior art, the present disclosure is intended to obtain a new failure probability prediction formula according to the Weibull Theory and a natural attribute of a brittle material with a uniaxial creep failure strain presenting a probability distribution to more accurately predict a failure probability of the brittle material in a high temperature creep state.

A technical solution adopted to solve the above technical problems in the present disclosure is as follows: a method of predicting a failure probability of a brittle material in a high temperature creep state is provided, including the following steps.

At step 1, assuming an uniaxial creep failure strain ε_{f} reflecting an attribute of the brittle material obeys the Weibull Distribution according to a natural attribute of random distribution of internal defects of the brittle material, a probability density function f(ε_{f}) of the uniaxial creep failure strain satisfies the following formula (1):

$$f ( {ɛ}_{f} ) = \frac{β}{η} {( \frac{{ɛ}_{f}}{η} )}^{β - 1} exp [ - {( \frac{{ɛ}_{f}}{η} )}^{β} ] \qquad ( 1 )$$

In the above formula (1):

η is a scale parameter of an variable, and η>0;

β is a shape paremeter of an variable, β>0.

At step 2, a probability density distribution function f(ε_{f}*) of a multiaxial creep failure strain shown in the formula (3) is obtained according to a mathematical conversion relationship of uniaxial and multiaxial creep failure strains ε_{f} * shown in the formula (2) (this formula is well known in the prior art).

$${ɛ}_{f}^{*} = exp [ \frac{2}{3} ( \frac{n - 0.5}{n + 0.5} ) ] / exp [ 2 ( \frac{n - 0.5}{n + 0.5} ) \frac{{σ}_{m}}{{σ}_{eq}} ] {ɛ}_{f} \qquad ( 2 )$$

In the above formula (2),

σₘ is a hydrostatic stress borne by the material;

σ_{eq} is a Von Mises stress; and

η is a creep exponent.

$$exp [ \frac{2}{3} ( \frac{n - 0.5}{n + 0.5} ) ] / exp [ 2 ( \frac{n - 0.5}{n + 0.5} ) \frac{{σ}_{m}}{{σ}_{eq}} ]$$

is an coefficient irrelevant to the uniaxial creep failure strain; it is conclude that the multiaxial creep failure strain ε_{f} * obeys the Weibull Distribution, and a mathematical expression (3) of a probability density distribution function of the multiaxial creep failure strain is as follows:

$$f ( {ɛ}_{f}^{*} ) = \frac{β}{η} {( \frac{{ɛ}_{f}^{*}}{η} )}^{β - 1} exp [ - {( \frac{{ɛ}_{f}^{*}}{η} )}^{β} ] \qquad ( 3 )$$

At step 3, a calculation expression of a failure probability shown in the formula (4) below is obtained by performing integration for the mathematical expression (3) of the probability density distribution function of the multiaxial creep failure strain according to a principle that a condition of a structural failure is that an equivalent creep strain value εₑ is greater than a multiaxial creep failure strain value ε_{f}* :

$${P}_{F 0} = {\int }_{0}^{{ɛ}_{e}} f ( {ɛ}_{f}^{*} ) d {ɛ}_{f}^{*} = 1 - exp [ - {( \frac{{ɛ}_{e}}{η} )}^{β} ] \qquad ( 4 )$$

On this basis, considering different internal defects of the material, a corresponding failure probability expression (5) below is obtained for a brittle material sample with a volume V by considering a volume effect:

$$P = 1 - exp [ - {( \frac{{ɛ}_{e}}{η} )}^{β} \frac{V}{{V}_{0}} ] \qquad ( 5 )$$

In above formula (5),

V₀ is a feature volume.

At step 4, under the same test condition, an uniaxial creep fracture test is performed for a plurality of groups of samples with volumes being V₀ at the same stress level, each fracture creep strain value is recorded, and a histogram of cumulative distribution of the uniaxial creep failure strain values is drawn with a creep fracture strain as an abscissa, and the number of fractured samples in a particular creep fracture strain interval as an ordinate.

At step 5, a fracture probability value P_{F0} of the samples with a volume being V₀ in each creep fracture strain interval is obtained by dividing the number of fractured samples in each creep fracture stain interval by a total number of fractured samples according to the histogram of cumulative distribution of the uniaxial creep failure strain values drawn as above, and the following expression is obtained by substituting V₀ and P_{F0} into the above calculation formula of failure probability (4) and taking logarithm two times on both sides.

ln[−ln(1−P_{F0})]=βlnεₑ−ln η^{β} (6)

A curve of ln[−ln(1−P_{F0})] and ln εₑ is drawn according to test results of performing uniaxial creep fracture test for different samples at the same stress level, and a slope of a straight line obtained by linear regression is a parameter β and a parameter η is obtained according to an intercept of the obtained straight line and a y axis.

At step 6, a prediction result of a failure probability of the brittle material in the high temperature creep state is obtained by writing a sub-program by using a Fortran language and embedding the sub-program into a finite element software ABAQUS according to the above formula (5) in combination with a creep-damage constitutive equation.

The creep-damage constitutive equation is shown as follows:

$$\begin{matrix}{\dot{ɛ}}_{ij} = \frac{3}{2} B {σ}_{eq}^{n - 1} {{S}_{ij} [ 1 + {{β}_{0} ( \frac{{σ}_{1}}{{σ}_{eq}} )}^{2} ]}^{\frac{n + 1}{2}} & ( 7 ) \\ {β}_{0} = \frac{2 ρ}{n + 1} + \frac{( 2 n + 3 ) {ρ}^{2}}{{n ( n + 1 )}^{2}} + \frac{( n + 3 ) {ρ}^{3}}{9 {n ( n + 1 )}^{3}} + \frac{( n - 3 ) {ρ}^{4}}{108 {n ( n + 1 )}^{4}} & ( 8 ) \\ ρ = \frac{2 ( n + 1 )}{π \sqrt{1 + 3 / n}} {ω}^{3 / 2} & ( 9 ) \\ ω = {\int }_{0}^{t} \frac{{\dot{ɛ}}_{e}}{{ɛ}_{f}^{*}} & ( 10 )\end{matrix}$$

In the above formula, \dot{ε}ᵢⱼ is a creep strain, σ_{I} is a constant of a maximum principal stress B at a second stage of creep, β₀ is a function relating to a stress, ρ is a micro-crack damage parameter, and ω is a creep damage amount.

Preferably, a plurality of groups mentioned in step 4 of the above method of predicting a failure probability of a brittle material in a high temperature creep state is preferably 10-20 groups.

The technical effect brought by the above technical solution directly is that the technical principle and the theoretical basis of the present disclosure will be briefly described below so as to better understand the technical features of the present disclosure.

The theoretical basis of the above technical solution is as follows: the uniaxial creep failure strain is a parameter reflecting a creep performance of the brittle material; since defect distribution inside the brittle material is random, the uniaxial creep failure strain value obtained by the uniaxial creep test is also non-deterministic; and the Weibull Distribution is highly adapted to the reliability analysis of a structure containing a defect due to its strong fitting capability.

Thus, assuming the uniaxial creep failure strain obeys the Weibull Distribution, a size of the scale parameter η in the probability density distribution function

$$f ( {ɛ}_{f} ) = \frac{β}{η} {( \frac{{ɛ}_{f}}{η} )}^{β - 1} exp [ - {( \frac{{ɛ}_{f}}{η} )}^{β} ]$$

represents a size of a dispersion degree of distribution and the shape parameter β is selected as different values, positive and negative deviations and a symmetrical probability density function may be obtained respectively.

The weakest link hypothesis needs to be considered in the Weibull Theory, that is, it is considered that a structure is similar to tensile N links under a constant uniaxial load, each link has a different failure strength, and the entire structure will fail when the weakest link fails. Thus, the strength of the link is relevant to the weakest link. A different failure strength of each link depends on a different defect inside the sample, i.e. “volume effect”: a larger sample volume means a larger internal defect and a larger stress strength will be generated correspondingly.

A failure probability expression corresponding to the samples with a volume being V is as follows:

$$P = 1 - {exp [ - {( \frac{{ɛ}_{e}}{η} )}^{β} \frac{V}{{V}_{0}} ]}_{∘}$$

That is, the calculation model for predicting a failure probability in the above technical solution performs correction to the calculation model of a failure probability based on stress in the prior art in a scientific and reasonable way.

Preferably, a plurality of groups mentioned in step 4 of the above method of predicting a failure probability of a brittle material in a high temperature creep state is preferably 10-20 groups. A technical effect brought directly by the preferred technical solution is as follows: our experiences show that an ideal prediction result may be obtained by performing an uniaxial creep fracture test for 10-20 groups of samples with volumes being V₀ at the same stress level under the same test condition while result reliability and working efficiency are considered.

Practices show that the present disclosure has the following benefits compared with the prior art:

1. The present disclosure better solves a problem that a reliability prediction cannot be performed for a brittle material in a high temperature creep state in the prior art.

2. The obtained prediction results are true, accurate, reasonable and reliable.

### BRIEF DESCRIPTION OF THE DRAWINGS

FIG. 1 is a flowchart illustrating a method of predicting a failure probability based on strain.

FIG. 2 is a schematic diagram illustrating a relationship of a sample volume size and a defect size.

FIG. 3 is a histogram illustrating a cumulative distribution of an uniaxial creep failure strain.

FIG. 4 is a relationship curve illustrating changes of an equivalent creep strain and a

Mises stress of a glass ceramic GC-9 material at 600° C. along with a creep time according to an example 1 of the present disclosure.

FIG. 5 is a comparison curve diagram illustrating a failure probability obtained for a glass ceramic GC-9 material at 600° C. based on a calculation model of a failure probability of the present disclosure and a failure probability obtained based on a calculation model of a failure probability based on stress in the prior art according to an example 1 of the present disclosure.

FIG. 6 is a relationship curve illustrating changes of an equivalent creep strain and a

Mises stress of a ceramic material YSZ at 650° C. along with a creep time according to an example 2 of the present disclosure.

FIG. 7 is a comparison curve diagram illustrating a failure probability obtained for a ceramic material YSZ at 650° C. based on a calculation model of a failure probability of the present disclosure and a failure probability obtained based on a calculation model of a failure probability based on stress in the prior art according to an example 2 of the present disclosure.

### DETAILED DESCRIPTION OF THE EMBODIMENTS

The present disclosure will be detailed below in combination with accompanying drawings and examples.

### EXAMPLE 1

A failure probability of a glass ceramic GC-9 material creeping for 50000 h at 600° C. is predicted.

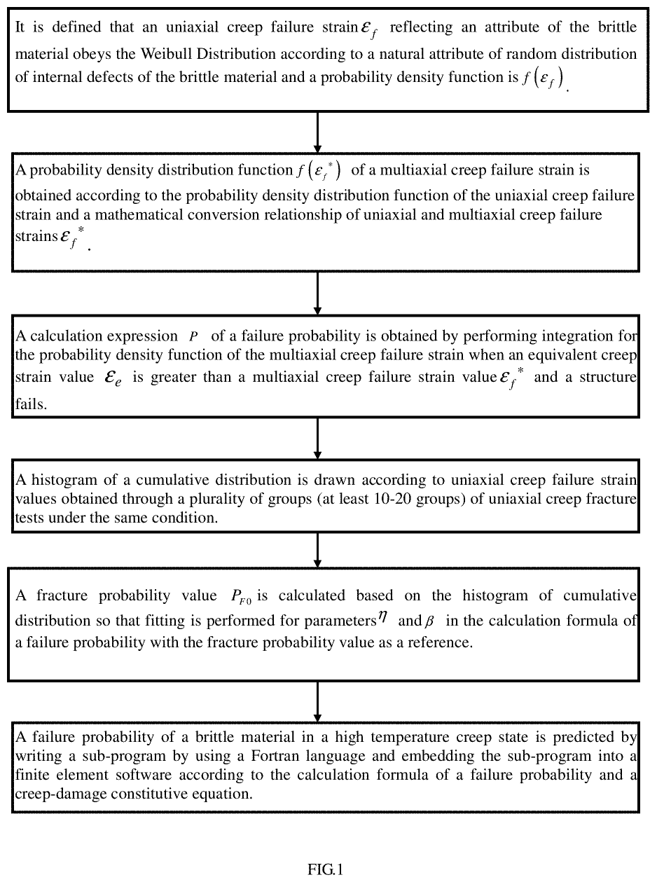

A process of predicting the failure probability of the glass ceramic GC-9 material creeping for 50000 h at 600° C. is performed according to the flow shown in FIG. 1.

### EXAMPLE 2

A failure probability of a ceramic material YSZ creeping for 50000 h at 650° C. is predicted.

A processing of predicting the failure probability of the ceramic material YSZ creeping for 50000 h at 650° C. is performed according to the flow shown in FIG. 1.

Parameters used in the calculation processes of example 1 and example 2 are shown in Table 1:

TABLE 1

| Material | B(MPa⁻ⁿh⁻¹) | n | ε_{f} | η | β | V | V₀ |
|---|---|---|---|---|---|---|---|
| YSZ | 1.1792e−016 | 1 | 0.02 | 0.1 | 8.6 | 0.0025 | 0.35 |
| GC | 2.3551e−014 | 5.943 | 0.01 | 0.07 | 6.0 | 0.025 | 1 |

The weakest link hypothesis needs to be considered in the Weibull Theory, that is, it is considered that a structure is similar to tensile N links under a constant uniaxial load, each link has a different failure strength, and the entire structure will fail when the weakest link fails. Thus, the strength of the link is relevant to the weakest link. A different failure strength of each link depends on a different defect inside the sample, i.e. “volume effect”.

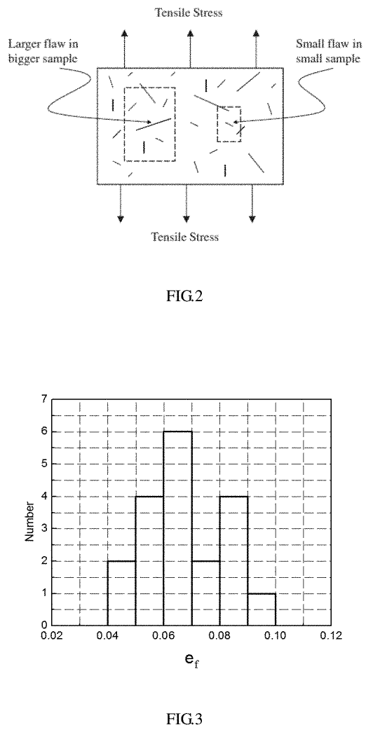

FIG. 2 is a schematic diagram illustrating a relationship of a sample volume size and a defect size according to an example of the present disclosure. As shown in FIG. 2, a larger sample volume means a larger internal defect and a larger stress strength is generated correspondingly.

FIG. 3 is a histogram of a cumulative distribution of an uniaxial creep failure strain according to an example of the present disclosure. As shown in FIG. 3, under the same test condition, an uniaxial creep fracture test is performed for a plurality of groups of samples with volumes being V₀ at the same stress level, each fracture creep strain value is recorded, and a histogram of cumulative distribution of the uniaxial creep failure strain values is drawn with a creep fracture strain as an abscissa, and the number of fractured samples in a particular creep fracture strain interval as an ordinate.

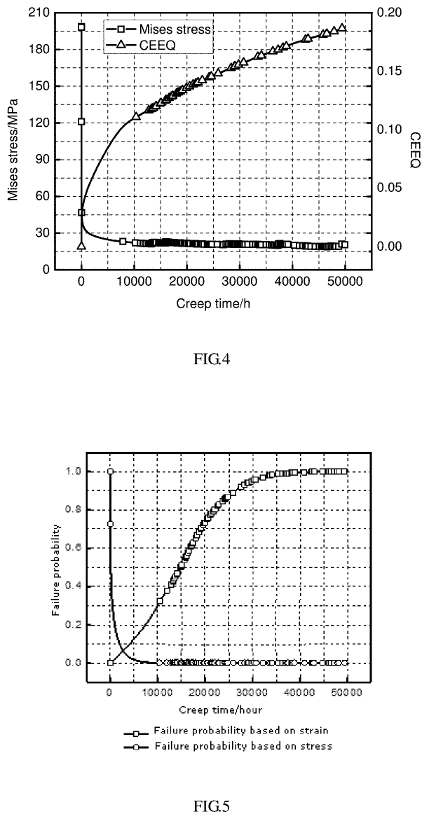

FIG. 4 is a relationship curve illustrating changes of an equivalent creep strain and a Mises stress along with a creep time according to an example 1 of the present disclosure. FIG. 5 is a comparison curve diagram illustrating a failure probability obtained for a glass ceramic GC-9 material at 600° C. based on a calculation model of a failure probability of the present disclosure and a failure probability obtained based on a calculation model of a failure probability based on stress in the prior art according to an example of the present disclosure.

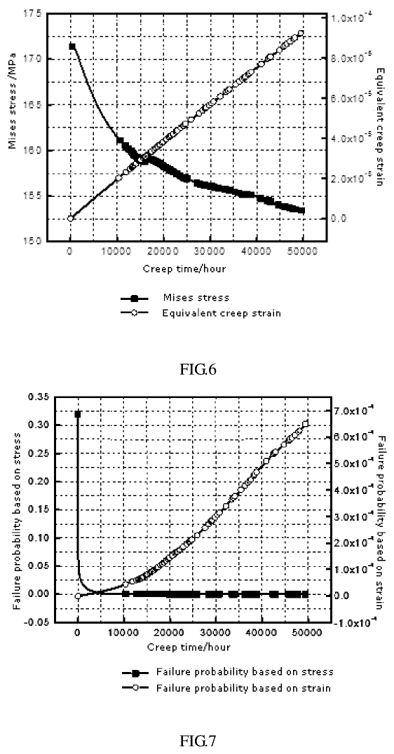

FIG. 6 is a relationship curve illustrating changes of an equivalent creep strain and a Mises stress of a ceramic material YSZ along with a creep time according to an example 2 of the present disclosure. FIG. 7 is a comparison curve diagram illustrating a failure probability obtained for a ceramic material YSZ at 650° C. based on a calculation model of a failure probability of the present disclosure and a failure probability obtained based on a calculation model of a failure probability based on stress in the prior art according to an example of the present disclosure.

As can be seen from FIGS. 5-7, the failure probability of the calculation model of failure probability based on strain in the present disclosure increases along with increase of time, which conforms to the actual situations of engineering. The structure of the brittle material will be subjected to increasing creep deformation (as shown in FIG. 4 and FIG. 6) and damage during a long time service at a high temperature, the possibility of damage also will increase and the structural reliability will become worse and worse, and therefore the failure probability gradually increases.

The failure probability obtained based on the calculation model of a failure probability based on stress in the prior art will decrease along with increase of time. Because a stress relaxation phenomenon may occur during a creep process and a stress will gradually decrease (as shown in FIG. 4 and FIG. 6), the failure probability will gradually decrease, which does not conform to the actual situations. Thus, the calculation model of a failure probability based on stress in the prior art will not be used for calculating a failure probability in a high temperature creep state.

A comparison result of FIG. 5 and FIG. 7 further proves the above conclusion.

The comparison result of FIG. 5 and FIG. 7 clearly shows that the prediction result obtained for a failure probability of a brittle material in a high temperature creep state based on the calculation model of a failure probability based on strain in the present disclosure is truer, more accurate, more reasonable and more reliable compared with the prior art.

Of course, the foregoing descriptions are not limiting of the present disclosure and the present disclosure is also not limited to the above examples. Any changes, modifications, additions or substitutions made by those skilled in the art without departing from the substantial scope of the present disclosure shall all fall within the scope of protection of the present disclosure.

1. A method of predicting a failure probability of a brittle material in a high temperature creep state, comprising the following steps:
at step 1, assuming an uniaxial creep failure strain ε_{f} reflecting an attribute of the brittle material obeys the Weibull Distribution according to a natural attribute of random distribution of internal defects of the brittle material, a probability density function f(ε_{f}) of the uniaxial creep failure strain satisfying the following formula (1):
$$f ( {ɛ}_{f} ) = \frac{β}{η} {( \frac{{ɛ}_{f}}{η} )}^{β - 1} exp [ - {( \frac{{ɛ}_{f}}{η} )}^{β} ] \qquad ( 1 )$$
in the formula (1):
η being a scale parameter of an variable, η>0;
β being a shape paremeter of an variable, β>0;
at step 2, obtaining a probability density distribution function f(ε_{f}*) of a multiaxial creep failure strain shown in the formula (3) is obtained according to a mathematical conversion relationship of uniaxial and multiaxial creep failure strains ε_{f} * shown in the formula (2):
$${ɛ}_{f}^{*} = exp [ \frac{2}{3} ( \frac{n - 0.5}{n + 0.5} ) ] / exp [ 2 ( \frac{n - 0.5}{n + 0.5} ) \frac{{σ}_{m}}{{σ}_{eq}} ] {ɛ}_{f} \qquad ( 2 )$$
in the formula (2),
σₘ being a hydrostatic stress borne by the material;
σ_{eq} being a Mises stress; and
η being a creep exponent;
$$exp [ \frac{2}{3} ( \frac{n - 0.5}{n + 0.5} ) ] / exp [ 2 ( \frac{n - 0.5}{n + 0.5} ) \frac{{σ}_{m}}{{σ}_{eq}} ]$$
being an coefficient irrelevant to the uniaxial creep failure strain; concluding that the multiaxial creep failure strain ε_{f} * obeys the Weibull Distribution, and a mathematical expression (3) of a probability density distribution function of the multiaxial creep failure strain is as follows:
$$f ( {ɛ}_{f}^{*} ) = \frac{β}{η} {( \frac{{ɛ}_{f}^{*}}{η} )}^{β - 1} exp [ - {( \frac{{ɛ}_{f}^{*}}{η} )}^{β} ] \qquad ( 3 )$$
at step 3, obtaining a calculation expression of a failure probability shown in the formula (4) below by performing integration for the mathematical expression (3) of the probability density distribution function of the multiaxial creep failure strain according to a principle that a condition of a structural failure is that an equivalent creep strain value εₑ is greater than a multiaxial creep failure strain value ε_{f}* :
$${P}_{F 0} = {\int }_{0}^{{ɛ}_{e}} f ( {ɛ}_{f}^{*} ) d {ɛ}_{f}^{*} = 1 - exp [ - {( \frac{{ɛ}_{e}}{η} )}^{β} ] \qquad ( 4 )$$
on this basis, considering different internal defects of the material, obtaining a corresponding failure probability expression (5) below for a brittle material sample with a volume V by considering a volume effect:
$$P = 1 - exp [ - {( \frac{{ɛ}_{e}}{η} )}^{β} \frac{V}{{V}_{0}} ] \qquad ( 5 )$$
in the formula (5),
V₀ being a feature volume;
at step 4, under the same test condition, performing an uniaxial creep fracture test for a plurality of groups of samples with volumes being V₀ at the same stress level, each fracture creep strain value being recorded, and drawing a histogram of cumulative distribution of the uniaxial creep failure strain values with a creep fracture strain as an abscissa, and the number of fractured samples in a particular creep fracture strain interval as an ordinate;
at step 5, obtaining a fracture probability value P_{F0} of the samples with a volume being V₀ in each creep fracture strain interval by dividing the number of fractured samples in each creep fracture stain interval by a total number of fractured samples according to the histogram of cumulative distribution of the uniaxial creep failure strain values drawn as above, and obtaining the following expression by substituting V₀ and P_{F0} the above calculation formula of failure probability (4) and taking logarithm two times on both sides:
ln[−ln(1−P_{F0})]=βlnεₑ−ln η^{β} (6)
drawing a curve of ln[−ln(1−P_{F0})] and ln εₑ according to test results of performing uniaxial creep fracture test for different samples at the same stress level, and a slope of a straight line obtained by linear regression being a parameter β and obtaining a parameter η according to an intercept of the obtained straight line and a y axis; and
at step 6, obtaining a prediction result of a failure probability of the brittle material in the high temperature creep state by writing a sub-program by using a Fortran language and embedding the sub-program into a finite element software ABAQUS according to the above formula (5) in combination with a creep-damage constitutive equation.

2. The method according to claim 1, wherein a plurality of groups mentioned in step 4 is 10-20 groups.
